(19) United States
(12) Patent Application Publication
(10) Pub. No.: US 2021/0310777 A1
(43) Pub. Date: Oct. 7, 2021

(54) CARTRIDGE CHAMBER AND CARTRIDGE CASE

(71) Applicants: Jan ZATLOUKAL, Rychnov nad Kneznou (CZ); Vladimír JELÍNEK, Vysoká Pec (CZ)

(72) Inventors: Jan ZATLOUKAL, Rychnov nad Kneznou (CZ); Vladimír JELÍNEK, Vysoká Pec (CZ)

(21) Appl. No.: 17/267,071

(22) PCT Filed: Jul. 30, 2019
(86) PCT No.: PCT/CZ2019/000036

§ 371 Date: Feb. 9, 2021

(30) Foreign Application Priority Data
Aug. 10, 2018 (CZ) PV2018-412

(51) Int. Cl. F42B 35/00; F41A 21/12; F42B 5/02; F42B 5/26

(52) U.S. Cl. CPC F42B 35/00; F42B 5/26; F42B 5/025; F41A 21/12

(57) ABSTRACT

A cartridge chamber, specifically a cartridge chamber of a hand-held firearm for loading cartridges consisting of a bullet and a cartridge case comprising an inner surface of the cartridge chamber where the cartridge chamber in the direction from the barrel mouth, terminates with a head of the breechblock, where the inner surface of the cartridge chamber comprises at least one shaped recess for carrying out the marking of the cartridge case. A cartridge case, specifically a cartridge case of a cartridge, after shooting a bullet fired from the cartridge chamber, which contains on its outer surface at least one trace of the shaped recess of the inner surface of the cartridge chamber.

### TECHNICAL FIELD

The invention relates to a cartridge chamber with a shaped recess for marking a cartridge case and the cartridge case marked with this shaped recess.

### STATE OF THE ART

Currently, the registration of weapons is based on the registration numbers of the main parts of the weapon. By law, the main part of the weapon is considered to be the barrel, the breech, the hinge, a frame, and in a revolver, the cylinder. For long guns, a typical frame, hinge and barrel make up the common integral unit. The main parts of the weapon are typically number-stamped in such a way that if the number is removed by grinding or otherwise, the weapon will not be damaged and it remains fireable. Additionally, to identify the weapon with a bullet and cartridge, it is necessary to have the specific physical weapon available for forensic analysis.

A wide range of cartridge chambers are currently known. For example, from the utility model CZ 27456 U is known a divided cartridge chamber for Flobert cartridges with limited or unlimited kinetic energy of the projectiles or small caliber cartridges, divided longitudinally, in which the dividing plane is identical to the longitudinal axis of the barrel bore. The cartridge chamber consists of a sliding part and a fixed part.

Furthermore it is known that cartridge cases are marked at the bottom so that identification information is printed or stamped on them.

It is also known that various specific chemical components are added to the reservoir to leave traces on the inside of the cartridge chamber. This makes it possible to identify that a charge from a particular series has been fired from a particular weapon.

From current technology, it is not known how to easily and without doubt identify a found cartridge and the weapon from which the cartridge was fired. This is also the main disadvantage of current technology.

The object of the invention to provide a cartridge chamber design that allows for the simple and unambiguous identification of a cartridge fired from it.

### PRINCIPLE OF THE INVENTION

The above drawbacks are largely eliminated and the object of the invention fulfilled by a cartridge chamber, specifically by a cartridge chamber of a hand-held firearm for storing cartridges consisting of bullets and a cartridge case, comprising an inner surface of the cartridge chamber, where the cartridge chamber, in the direction from the mouth of the barrel, ends with a head of the breechblock whose, according to the invention, essence lies in that the inner surface of the cartridge chamber comprises at least one shaped recess for marking the cartridge case. The advantage is that one can easily and at the same time very clearly mark each cartridge case of the bullet fired from a particular firearm.

According to the first advantageous variant, the shaped recess is arranged on the inner surface of the cartridge chamber in such a way that it is completely within the space for placing the cartridge case. The shaped recess is so designed to form shaped traces on the cartridge case, so that when the charge is fired, the walls of the cartridge case is pressed by internal overpressure of the burning gunpowder gases against the walls of the cartridge chamber. The advantage of this is that these shaped traces thus formed on the cartridge, which are deformations of its shell, are virtually indestructible or to be more precise, irremovable.

According to the second variant, which appears to be the most advantageous, the shaped recess is arranged on the inner surface of the cartridge chamber in such a way that it extends beyond the space in which the inner wall of the cartridge chamber abuts the wall of the cartridge case. The shaped recess is formed so as to form a gas trace on the cartridge case, whereby the cartridge case is marked with residual pressurised gases on the sides of the fired cartridge case, their carbon prints being left on the sides of the cartridge. The advantage is that the gas marking is very simple to carry out and at the same time sufficient for accurate identification. The point being that committing an offence is usually very stressful for offenders, and therefore he does not have time to collect all the fired cartridges, and so the mere marking of the cartridge cases by pressurised gas traces is sufficient to identify the weapon and the perpetrator. It is also very important that the cartridge case is not deformed, and thus the risk of jamming or disrupting the safe and rapid emptying of the cartridge chamber is also not increased.

With view to the speed and ease of identification of the cartridge cases, it is then highly advantageous if the shaped recess is in the form of a graphic and/or pictorial and/or alphanumeric character.

It is to further advantage for creating perfect markings that the shaped recess has a depth of at least 10 μm.

In terms of production simplicity, it is further to advantage that the shaped recess is provided by being stamped or machined and/or chipping machining and/or laser ablation.

It is very important that the shaped recess is made so it is indelible without damaging the weapon. This is ensured by additional design elements which, for example, guarantee that when an attempt is made to grind the chamber, it disintegrates or is damaged so that it cannot be further fired from.

The aforementioned disadvantages are further largely eliminated and the object of the invention is fulfilled by cartridge cases, in particular cartridge case cartridges, fired from a cartridge chamber according to the invention, which include on their external surface at least one recessed mark from the interior of the cartridge chamber.

It is to advantage that this trace of the shaped recess from the interior surface of the cartridge chamber is a shaped trace which is substantially a mechanical deformation of the outer surface of the cartridge case.

But in the most advantageous variant, the shape of the recess of the inner surface of the cartridge chamber is a coloured gas trace from the residual pressurised gas after the shot is fired.

The main advantage of the design of the cartridge chamber according to the invention is that the shaped recesses provided on the walls of the cartridge chamber very simply ensure the exact identification of each used cartridge case and with this its rapid identification with the weapon in which it was used. Shaped recesses can already be made at the time of weapon production, or can be provided while you wait during periodic checks of registered weapons when extending the validity of firearms licenses.

### OVERVIEW OF THE FIGURES

The invention will be further elucidated using drawings, in which

FIG. 1 shows a cartridge chamber with a cartridge which includes recesses for marking the cartridge cases with a gas trace created by residual pressurised gas after firing,

FIG. 2 shows a cartridge chamber with a cartridge, which includes a shaped recess to mark the cartridge with a shaped trace which is a mechanical deformation of the cartridge case, and

FIG. 3 shows a cartridge chamber with a cartridge which includes a shaped recess for marking the cartridge with both a gas trace as well as a shaped trace.

### EXAMPLES OF THE PERFORMANCE OF THE INVENTION

### Example 1

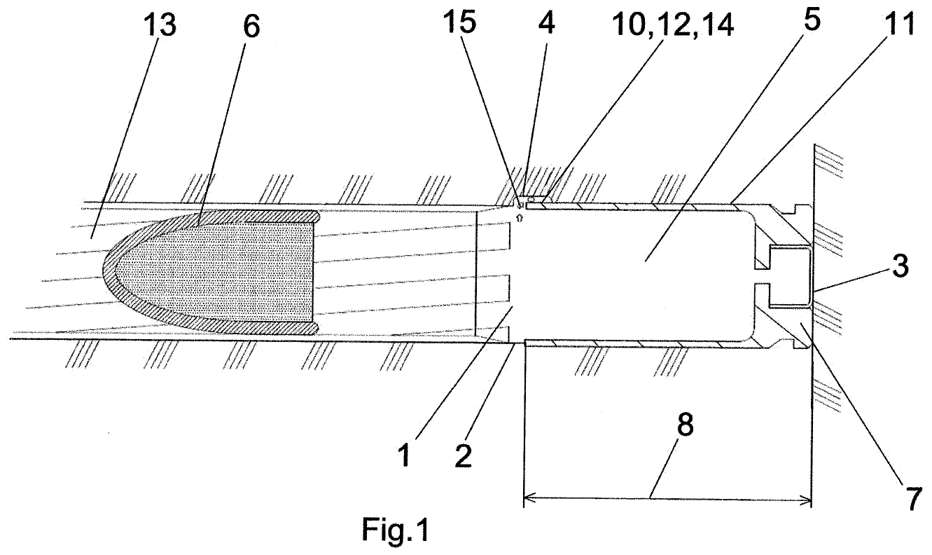

A cartridge chamber 1 of a hand-held firearm (FIG. 1) for loading cartridges 7 consisting of a bullet 6 and a cartridge case 5 comprising an inner surface 2 of the cartridge chamber 1 where the cartridge chamber 1, in the direction from the barrel mouth 13, terminates with a head 3 of the breechblock.

The inner surface 2 of the cartridge chamber 1 comprises a plurality of shaped recesses 4 for carrying out marking 10 of the cartridge case 5, where the shaped recesses 4 are arranged on the inner surface 2 of the cartridge chamber 1 so as to extend beyond the space 8 in which the inner surface 2 of the cartridge chamber 1 abuts the wall of the cartridge case 5. The shaped recesses 4 are arranged for marking 10 the cartridge 5 with residual 15 pressurised gases burning from the spent cartridge 7, with these residual 15 pressurised gases creating carbon prints.

The shaped recesses 4 form a so-called bar code which consists of graphical and alphanumeric characters.

The shaped recesses 4 have a depth in the range of 10 to 50 μm and are made by electroerosion machining. Alternatively, the recesses 4 may be stamped and/or chipping machined and/or laser ablated.

The shaped recesses 4 are made to be irremovable without damaging the weapon.

The cartridge case 5 along the bullet 6 fired from the cartridge chamber 1 comprises on its outer surface 11 a plurality of traces 14 of the shaped recesses 4 of the inner surface 2 of the cartridge chamber 1. These traces 14 are coloured gas traces 12 of the residual 15 pressurised gases after firing, they are in essence, carbon prints by means of which a barcode (not shown) consisting of graphical and alphanumeric characters is created.

### Example 2

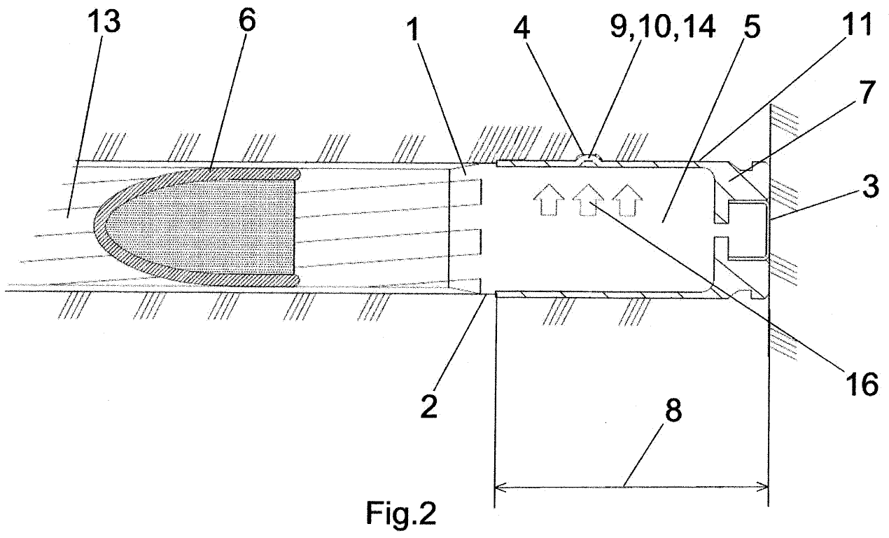

A cartridge chamber 1 of a hand-held firearm (FIG. 2) for loading cartridges 7 consisting of a bullet 6 and a cartridge case 5 comprising an inner surface 2 of the cartridge chamber 1 where the cartridge chamber 1, in the direction from the barrel mouth 13, terminates with a head 3 of the breechblock.

The inner surface 2 of the cartridge chamber 1 comprises a plurality of shaped recesses 4 for carrying out marking 10 of the cartridge case 5, where the shaped recesses 4 are arranged on the inner surface 2 of the cartridge chamber 1 so that they are completely inside the space 8 for loading the cartridge case 5. The shaped recesses 4 are provided to create shaped traces 9 on the cartridge case 5 by means of an overpressure 16 of gas, these shaped traces 9 forming on the cartridge case 5, a plurality of small protrusions.

The shaped recesses 4 create an image character and several alphanumeric characters.

The shaped recesses 4 have a depth of approximately 20 μm, and are made by laser ablation. Alternatively, the shaped recesses 4 may be stamped and/or chipping machined and/or electroerosion machined.

The shaped recesses 4 are made to be irremovable without damaging the weapon.

The cartridge case 5 of the cartridge 7 along the bullet 6 fired from the cartridge chamber 1 comprises on its outer surface 11 a plurality of traces 14 of the shaped recesses 4 of the inner surface 2 of the cartridge chamber 1, the shaped traces 9 being small protrusions created by the mechanical deformations of the outer surface 11 of the cartridge case 5 which create a single image character and several alphanumeric characters.

### Example 3

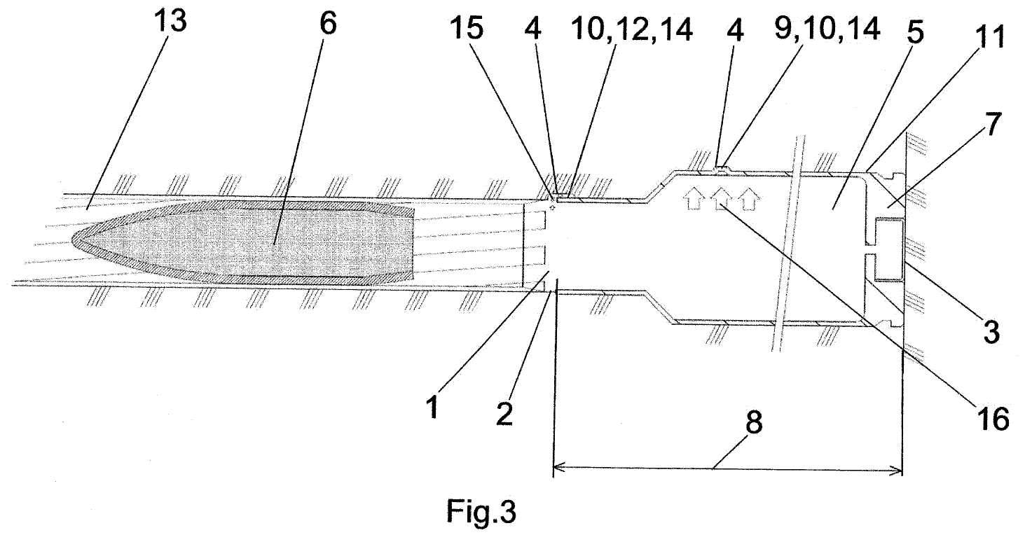

A cartridge chamber 1 of a firearm (FIG. 3) for loading cartridges 7 consisting of a bullet 6 and a cartridge case 5 comprising an inner surface 2 of the cartridge chamber 1 where the cartridge chamber 1, in the direction from the barrel mouth 13, terminates with a head 3 of the breechblock.

The inner surface 2 of the cartridge chamber 1 comprises a plurality of shaped recesses 4 for carrying out marking 10 of the cartridge case 5, where the shaped recesses 4 are arranged on the inner surface 2 of the cartridge chamber 1 so that they extend beyond the space 8 in which the inner surface 2 of the cartridge chamber 1 abuts the wall of the cartridge case 5. The shaped recesses 4 for carrying out marking 10 of the cartridge case 5 with the residual 15 gases from the burning of the spent cartridge 7, with these residual 15 pressurised gases creating carbon prints. These shaped recesses 4 form an alphanumeric code consisting of alphanumeric characters.

At the same time, further shaped recesses 4 are arranged on the inner surface 2 of the cartridge chamber 1 so that they are entirely within the space 8 for placement of the cartridge case 5. These shaped recesses 4 are provided to create shaped traces 9 on the cartridge case 5 by means of an overpressure 16 of gas while forming on the cartridge case 5, a plurality of small protrusions. These shaped recesses 4 form an image symbol.

The shaped recesses 4 have a depth in the range of 10 to 60 μm and are made using electroerosion machining and laser ablation.

The shaped recesses 4 are made to be irremovable without damaging the weapon.

The cartridge case 5 of the cartridge 7 along the bullet 6 fired from the cartridge chamber 1 comprises on its outer surface 11 a plurality of traces 14 of the shaped recesses 4 of the inner surface 2 of the cartridge chamber 1 these traces 14 creating both coloured carbon residues 15 of the pressurised gases after firing which produces on the outer surface 11 of the cartridge case 5 an alphanumeric code consisting of alphanumeric characters. Further traces 14, which are shaped traces 9 in the form of small protrusions formed by mechanical deformations of the outer surface 11 of the cartridge case 5, then form an image symbol on the outer surface 11 of the cartridge case 5.

### INDUSTRIAL APPLICATION

The cartridge chamber and the cartridge according to the invention can be used to simplify the identification of the firearm from which it was fired, which greatly simplifies the identification of the perpetrator of a criminal offence.

1. A cartridge chamber for a hand-held firearm for loading cartridges, comprising
a bullet and
a cartridge case including an inner surface of the cartridge chamber where the cartridge chamber, in the direction from a barrel mouth, terminates with a head of a breechblock,
wherein the inner surface of the cartridge chamber includes at least one shaped recess configured to carry out marking of the cartridge case.

2. The cartridge chamber according to claim 1, wherein the shaped recess is arranged on the inner surface of the cartridge chamber so that the shaped recess is completely inside a space for placing the cartridge case.

3. The cartridge chamber according to claim 1, wherein the shaped recess is arranged on the inner surface of the cartridge chamber so that the shaped recess extends beyond a space in which the inner surface of the cartridge chamber abuts a wall of the cartridge case.

4. The cartridge chamber according to claim 1, wherein the shaped recess is in the form of a graphic and/or pictorial and/or alphanumeric character.

5. The cartridge chamber according to claim 1, wherein the shaped recess has a depth of at least 10 μm.

6. The cartridge chamber according to claim 2, wherein the shaped recess is configured to create a shaped trace on the cartridge case.

7. The cartridge chamber according to claim 3, wherein the shaped recess is configured to mark the cartridge case with residues of pressurised gases from a firing of a spent cartridge.

8. The cartridge chamber according to claim 1, wherein the shaped recess is made using stamping or chip machining and/or electroerosion machining and/or laser ablation.

9. The cartridge chamber according to claim 1, wherein the shaped recess is configured to be irremovable without damaging the firearm.

10. A cartridge case of a cartridge, along a bullet fired from a cartridge chamber according to claim 1 wherein the cartridge case contains on an outer surface of the cartridge case at least one trace of the shaped recess of the inner surface of the cartridge chamber.

11. The cartridge case according to claim 10, wherein the trace of the shaped recess of the inner surface of the cartridge chamber is a shaped trace.

12. The cartridge case according to claim 10, wherein the trace of the shaped recess of the inner surface of the chamber is a coloured gas trace of the residue from a pressurised gas after firing.
